(19) United States
(12) Patent Application Publication
(10) Pub. No.: US 2005/0135707 A1
(43) Pub. Date: Jun. 23, 2005

(54) Method and apparatus for registration of lung image data

(76) Inventors: Matthew William Turek, Ballston Lake, NY (US); William Edward Lorensen, Ballston Lake, NY (US); James Vradenburg Miller, Clifton Park, NY (US)

Correspondence Address: Patrick S. Yoder;FLETCHER YODER, P.O. Box 692289, Houston, TX, 77269-2289, US

(21) Appl. No.: 10/739,546

(22) Filed: Dec. 18, 2003

(51) Int. Cl. G06K 9/00; G06K 9/32

(52) U.S. Cl. 382/294; 382/128

(57) ABSTRACT

A technique for registering image data is provided. The technique comprises accessing a plurality of image data sets comprising image data representative of a plurality of pixels. Then, a lung pleural region of interest is segmented within the image data of each data set. A plurality of pixel correspondences are identified within the segmented region of interest between the image data sets. The plurality of pixel correspondences are then aligned within the segmented region of interest between the data sets to generate registered image data sets, in which the lung pleural region of interest is registered between the plurality of image data sets.

### BACKGROUND OF THE INVENTION

The present invention relates generally to the field of medical imaging. More particularly, the invention relates to techniques for analyzing features of lung images by registering regions, particularly pleural regions of the lung in different images made at different points in time.

There are many applications for medical imaging technologies, particularly in the diagnosis and treatment of disease. Within the medical imaging field, moreover, there are many imaging modalities and types of image acquisition and processing protocols that are specifically adapted to imaging different tissues and anatomies. In general, the modality will be selected depending upon the type of tissue of interest and the type of condition suspected to be visible in the resulting images. Each of these techniques holds particular challenges, particularly for obtaining clear and useful images that can serve as a reliable basis for diagnosis and treatment.

A particularly challenging application of medical imaging is in the field of lung imaging. A number of disease states affect the lungs, and their early detection, monitoring, and treatment are important to a patient's health. Traditional techniques for lung imaging include X-ray imaging, computed tomography (CT) imaging, magnetic resonance imaging (MRI), and X-ray tomosynthesis. Each of these modalities can provide good images, but face challenges in providing acceptable contrast and resolution so as to permit comparison of different images. That is, because the pleural regions of the lungs are comprised primarily of air and tissue that provides less contrast than surrounding structures, internal features of the pleural regions are difficult to see in the reconstructed images. Comparison is thus rendered even more problematical.

Image comparison is desirable in certain contexts to compare differences in features of interest over time. For example, the appearance or disappearance of a growth or lesion in the pleural region of the lungs, or the growth or attrition of such tissues can be best monitored when multiple images of the same patient are compared. Traditionally, film-based images are displayed for a trained technician or radiologist, who moves from image to image, mentally recalling each image to develop an idea of changes between the imaged structures. While generally effective, such approaches are not amenable to automation and are hence time consuming and prone to significant variations in effectiveness between individuals.

In the case of lung pleural regions, in particular, alignment or registration techniques applicable to other types of images and anatomies are difficult or impossible to apply. In particular, registration techniques useful for aligning the bone or the lung ribcage are less reliable for registering the much less dense lung pleural regions such as due to lung movement, which is relatively greater than rib movement, particularly near the diaphragm. There is a need, therefore, for an improved approach to lung imaging, and particularly for aligning or registering different images, such as images taken at different points in time. There is, at present a particular need for a technique which would allow for registration of images of the pleural regions of the lungs and of features of interest visible in the pleural regions, but that may not permit ready application of conventional approaches due to the nature of the tissues making up the pleural regions.

### BRIEF DESCRIPTION OF THE INVENTION

The present invention provides techniques for processing and registering images of lung pleural regions designed to respond to such needs. The techniques may be used with images taken over relatively short or quite long spans of time for comparison purposes. Moreover, the techniques are amenable to use with images from different imaging modalities, particularly X-ray, CT, tomosynthesis and other systems commonly used to produce chest images of patients. Further, the technique may be employed to compare and contrast projection images, as obtained in X-ray imaging modalities, slice-type images, as generated in CT and tomosynthesis modalities, and may find application for registration of single images or multiple images (i.e., volumes).

In accordance with one aspect of the present technique, a technique for registering image data is provided. The technique comprises accessing a plurality of image data sets comprising lung image data. The image data comprises a plurality of pixels. Then, a lung pleural region is segmented within the image data of each data set. From, the segmented region, a plurality of pixel correspondences are identified within the region between the image data sets. The plurality of pixel correspondences are then aligned within the segmented region between the data sets to generate registered image data sets, in which the lung pleural region is registered between the plurality of image data sets.

In accordance with another aspect of the present technique, an imaging system for registering lung image data is provided. The system comprises an X-ray source configured to project an X-ray beam from a plurality of positions through a subject of interest and a detector configured to produce a plurality of signals corresponding to the X-ray beam. The system further comprises a processor configured to process the plurality of signals to generate the lung image data, wherein the lung image data is representative of a plurality of pixels. The processor is further configured to access a plurality of image data sets comprising the image data, segment a lung pleural region of interest within the image data of each data set, identify a plurality of pixel correspondences, within the segmented region of interest, between the image data sets and align the plurality of pixel correspondences, within the segmented region of interest, between the image data sets, to generate registered image data sets in which the lung pleural region of interest is registered between the plurality of image data sets.

### BRIEF DESCRIPTION OF THE DRAWINGS

The foregoing and other advantages and features of the invention will become apparent upon reading the following detailed description and upon reference to the drawings in which:

FIG. 1 is a general diagrammatical representation of certain functional components of an exemplary image data-producing system, in the form of a medical diagnostic imaging system used to produce lung images for registration in accordance with the present technique;

FIG. 2 is a diagrammatical view of an exemplary imaging system in the form of a CT imaging system for use in producing processed images in accordance with one embodiment of the present technique for lung region registration;

FIG. 3 is a diagrammatical representation of a digital X-ray image of a lung pleural region of a subject of interest, acquired via an imaging system of the type shown in FIG. 1, in this case a projection image, as from an X-ray system;

FIG. 4 is a cross-sectional image slice of a patient taken at the location of the feature of interest depicted in FIG. 3, by the CT system of the type shown in FIG. 2;

FIG. 5 is a diagrammatical representation of a segmented region of interest of the pleural regions of left and right lungs visible in the image depicted in FIG. 4 acquired at a first time T1;

FIG. 6 is a diagrammatical representation of a segmented region of interest of the pleural regions of left and right lungs visible in an image of the same patient acquired at a different time T2;

FIG. 7 is a diagrammatical representation of a digital composite image of the overlay of the left lung pleural region of a patient depicted in FIG. 5 and FIG. 6, acquired at different points in time; and

FIG. 8 is a flowchart describing exemplary steps for registering image data in accordance with embodiments of the present technique to permit comparison of images of the type shown in the previous figures.

### DETAILED DESCRIPTION OF SPECIFIC EMBODIMENTS

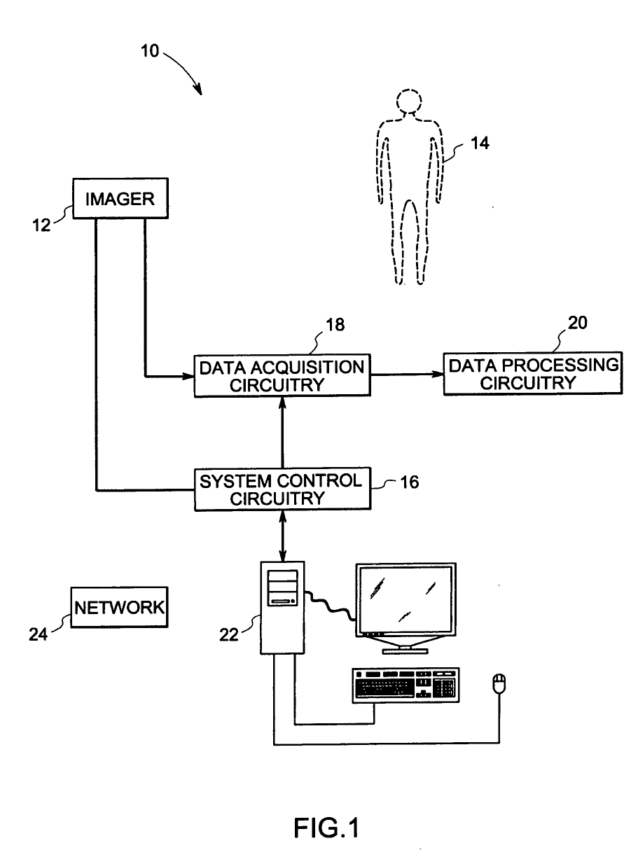

As noted above, the present techniques for registering lung pleural region images may be applied to different imaging modalities and image types. FIG. 1 is an overview of an imaging system 10 representative of various imaging modalities. The system 10 may be employed to produce images for registration in accordance with the present technique. An imaging system 10 generally includes some type of imager 12, which detects signals and converts the signals to useful data. As described more fully below, the imager 12 may operate in accordance with various physical principles for creating the image data. In general, however, image data indicative of regions of interest in a patient 14, and particularly the lung pleural regions with surrounding and included tissues, are created by the imager either in a conventional support, such as photographic film, or in a digital medium.

The imager 12 operates under the control of system control circuitry 16. The system control circuitry may include a wide range of circuits, such as radiation source control circuits, timing circuits, circuits for coordinating data acquisition in conjunction with patient or table of movements, circuits for controlling the position of radiation or other sources and of detectors, and so forth. The imager 12, following acquisition of the image data or signals, may process the signals, such as for conversion to digital values, and forwards the image data to data acquisition circuitry 18. In the case of analog media, such as photographic film, the data acquisition system may generally include supports for the film, as well as equipment for developing the film and producing hardcopies that may be subsequently digitized. For digital systems, the data acquisition circuitry 18 may perform a wide range of initial processing functions, such as adjustment of digital dynamic ranges, smoothing or sharpening of data, as well as compiling of data streams and files, where desired. The data is then transferred to data processing circuitry 20 where additional processing and analysis are performed. For conventional media such as photographic film, the data processing system may apply textual information to films, as well as attach certain notes or patient-identifying information. For the various digital imaging systems available, the data processing circuitry 20 may perform substantial analyses of data, ordering of data, sharpening, smoothing, feature recognition, and so forth.

It should be borne in mind that while references are made herein to several types of X-ray based imaging modalities, and the present techniques are particularly well suited for use with such modalities, other modality images may also benefit from the present registration approach. Moreover, even film-based X-ray systems may generate images that can be aligned or registered as described below, although generally following digitization (e.g., scanning) of the resulting film images to obtain digital data files that can be processed and analyzed as described.

Ultimately, the image data are forwarded to some type of operator interface 22 for viewing and analysis. While operations may be performed on the image data prior to viewing, the operator interface 22 is at some point useful for viewing reconstructed images based upon the image data collected. It should be noted that in the case of photographic film, images are typically posted on light boxes or similar displays to permit radiologists and attending physicians to more easily read and annotate image sequences. The images may also be stored in short or long-term storage devices, for the present purposes generally considered to be included within the interface 22, such as picture archiving communication systems (PACS). The image data can also be transferred to remote locations, such as via a network 24. It should also be noted that, from a general standpoint, the operator interface 22 affords control of the imaging system, typically through interface with the system control circuitry 16. Moreover, it should also be noted that more than a single operator interface 22 may be provided. Accordingly, an imaging scanner or station may include an interface which permits regulation of the parameters involved in the image data acquisition procedure, whereas a different operator interface may be provided for manipulating, enhancing, and viewing resulting reconstructed images.

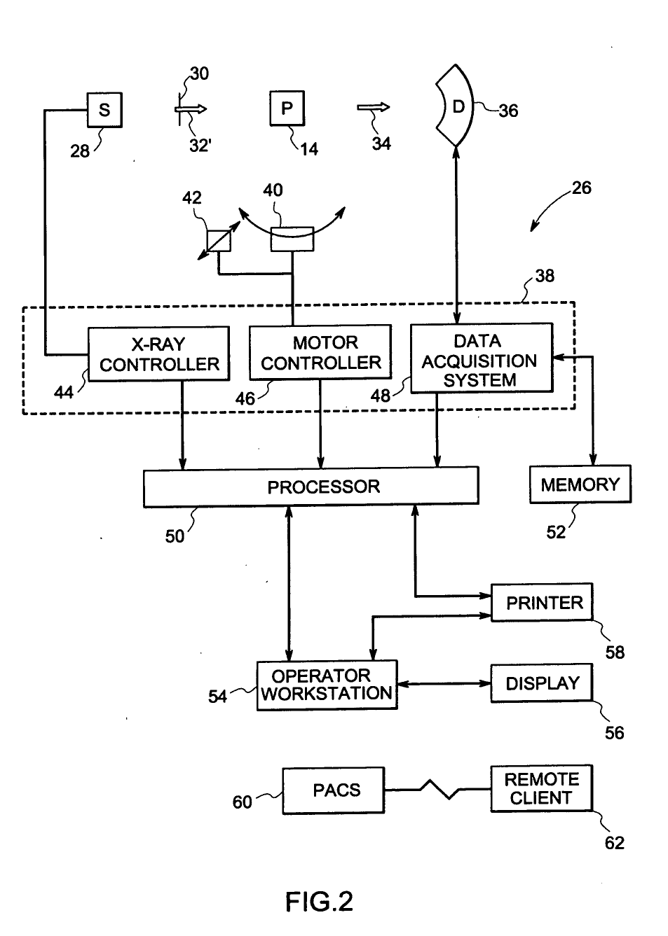

FIG. 2 illustrates diagrammatically a particular modality of an imaging system 26 for acquiring and processing image data. In the illustrated embodiment, system 26 is a computed tomography (CT) system designed both to acquire original image data, and to process the image data for display and analysis in accordance with the present technique. In the embodiment illustrated in FIG. 2, imaging system 26 includes a source of X-ray radiation 28 positioned adjacent to a collimator 30. In this exemplary embodiment, the source of X-ray radiation source 28 is typically an X-ray tube.

Collimator 30 permits a stream of radiation 32 to pass into a region in which an object, such as the patient 14 is positioned. A portion of the radiation 34 passes through or around the subject 14 and impacts a detector array, represented generally at reference numeral 36. Detector elements of the array produce electrical signals that represent the intensity of the incident X-ray beam. These signals are acquired and processed to reconstruct images of the features within the subject 14.

Source 28 is controlled by a system controller 38, which furnishes both power, and control signals for CT examination sequences. Moreover, detector 36 is coupled to the system controller 38, which commands acquisition of the signals generated in the detector 36. The system controller 38 may also execute various signal processing and filtration functions, such as for initial adjustment of dynamic ranges, interleaving of digital image data, and so forth. In general, system controller 38 commands operation of the imaging system to execute examination protocols and to process acquired data. In the present context, system controller 38 also includes signal processing circuitry, typically based upon a general purpose or application-specific digital computer, associated memory circuitry for storing programs and routines executed by the computer, as well as configuration parameters and image data, interface circuits, and so forth.

In the embodiment illustrated in FIG. 2, system controller 38 is coupled to a rotational subsystem 40 and a linear positioning subsystem 42. The rotational subsystem 40 enables the X-ray source 28, collimator 30 and the detector 36 to be rotated one or multiple turns around the subject 14. It should be noted that the rotational subsystem 40 might include a gantry. Thus, the system controller 38 may be utilized to operate the gantry. The linear positioning subsystem 42 enables the subject 14, or more specifically a table, to be displaced linearly. Thus, the table may be linearly moved within the gantry to generate images of particular areas of the subject 14.

Additionally, as will be appreciated by those skilled in the art, the source of radiation may be controlled by an X-ray controller 44 disposed within the system controller 38. Particularly, the X-ray controller 44 is configured to provide power and timing signals to the X-ray source 28. A motor controller 46 may be utilized to control the movement of the rotational subsystem 40 and the linear positioning subsystem 42.

Further, the system controller 38 is also illustrated comprising a data acquisition system 48. In this exemplary embodiment, the detector 36 is coupled to the system controller 38, and more particularly to the data acquisition system 48. The data acquisition system 48 receives data collected by readout electronics of the detector 36. The data acquisition system 48 typically receives sampled analog signals from the detector 36 and converts the data to digital signals for subsequent processing by a processor 50.

The processor 50 is typically coupled to the system controller 38. The data collected by the data acquisition system 48 may be transmitted to the processor 50 and moreover, to a memory 52. It should be understood that any type of memory to store a large amount of data might be utilized by such an exemplary system 26. Moreover, the memory 52 may be located at this acquisition system or may include remote components for storing data, processing parameters, and routines described below. Also the processor 50 is configured to receive commands and scanning parameters from an operator via an operator workstation 54 typically equipped with a keyboard and other input devices. An operator may control the system 26 via the input devices. Thus, the operator may observe the reconstructed image and other data relevant to the system from processor 50, initiate imaging, and so forth.

A display 56 coupled to the operator workstation 54 may be utilized to observe the reconstructed image and to control imaging. Additionally, the scanned image may also be printed by a printer 58 which may be coupled to the operator workstation 54. The display 56 and printer 58 may also be connected to the processor 50, either directly or via the operator workstation 54. Further, the operator workstation 54 may also be coupled to a picture archiving and communications system (PACS) 60. It should be noted that PACS 60 might be coupled to a remote system 62, radiology department information system (RIS), hospital information system (HIS) or to an internal or external network, so that others at different locations may gain access to the image and to the image data.

It should be further noted that the processor 50 and operator workstation 54 may be coupled to other output devices, which may include standard, or special purpose computer monitors and associated processing circuitry. One or more operator workstations 54 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

It should be borne in mind that the system of FIG. 2 is described herein as an exemplary system only. Other system configurations and operational principles may, of course, be envisaged for producing lung images that can be registered as described below.

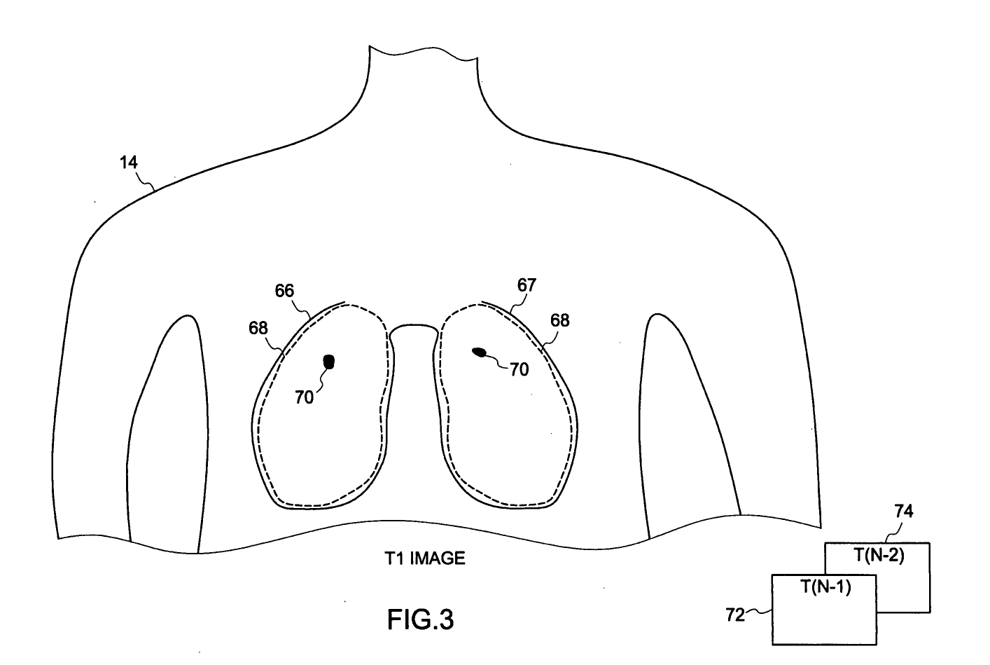

FIG. 3 is a diagrammatical representation of a digital X-ray image of a lung pleural region of a subject of interest, acquired via the imaging system 10 of the type shown in FIG. 1, in this case, an X-ray system projection image, or a tomosynthesis system reconstructed slice. With reference to FIG. 1, the system 10 acquires image data, processes it and forwards it to the data processing circuitry 20 where additional processing and analysis of the image data are performed. The images are typically analyzed for the presence of anomalies or indications of one or more medical pathologies, or even more generally, for particular features or structures of interest. In a specific embodiment of the present technique, the image data is representative of tissue within the lung pleural region of interest.

Referring again to FIG. 3, reference numerals 66 and 67 represent the left and right lungs of the patient 14. The lung pleural region is designated by the reference numeral 68, and reference numeral 70 represents a location of a feature of interest, such as an anomaly or a lesion in the lung pleural region 68 of the patient 14. Reference numerals 72 and 74 designate lung pleural images of the patient 14, acquired and generated at separate or earlier times, T (N−1) and T (N−2) respectively. The earlier collected images of the patient 14 generated at separate times enable the comparison of the images, by a clinician such as a physician to analyze progressions of the anomaly over time. As will be appreciated by those skilled in the art, the lung pleural region depicted in FIG. 3 is for illustrative purposes only and is not meant to limit the imaging of other types of images by the imaging system 10 such as for example, the heart, colon, limbs, breast or brain.

Images of the type shown in FIG. 3 present particular challenges for registration of lung pleural regions. As will be appreciated by those skilled in the art, X-ray based technologies rely upon attenuation or absorption of different tissues of the subject that result in different numbers or intensities of photons impacting a film or digital detector. Depending upon these different intensities, the resulting image data will encode corresponding intensities of received radiation at different spatial locations in the reconstructed image. The intensities thus provide contrast of picture elements or pixels so as to define an overall useful image when combined as shown in FIG. 3. However, tissues of the type found in the lung pleural regions do not typically provide high contrast sufficient to permit conventional registration techniques to be applied. This is due, in large part, to the much less dense nature of the tissues, which are generally filled with air. The present technique, as described more fully below, offers an effective approach to analysis of such image data, permitting registration and comparison of images of lung pleural regions.

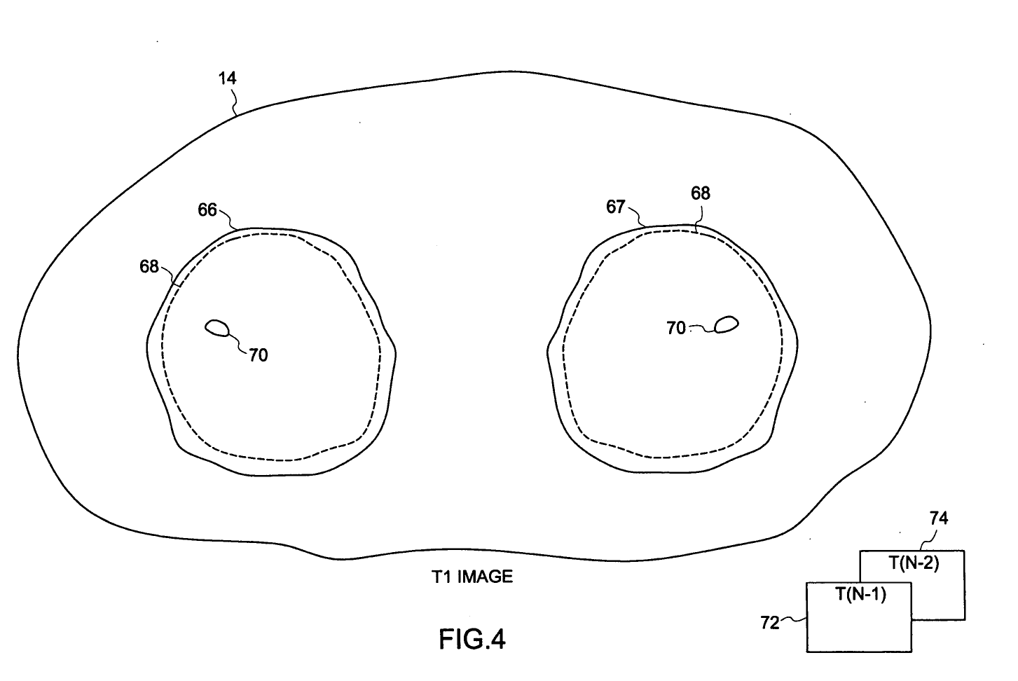

FIG. 4 is a cross-sectional image slice of the patient taken at the location of the feature of interest 70 depicted in FIG. 3, by the CT system 26 of the type shown in FIG. 2. Reference numerals, 72 and 74 represent lung pleural images of the patient 14, acquired and generated at separate or earlier times, T (N−1) and T (N−2) respectively. As will be appreciated by those skilled in the art, while operating in a different manner from conventional projection X-ray techniques, CT systems rely upon collection of data resulting from radiation traversing a subject. Various reconstruction techniques permit identification of the location, in a slice or in a volume, of structures that cause beam attenuation at particular pixel locations of the digital detector. Thus, here again, the lung pleural regions are difficult to analyze, register and compare, as between images taken at different points in time, due to the relatively low contrast provided by the less dense tissues of these regions. In addition, as will be appreciated by those skilled in the art, identifying and aligning pixel correspondences in the case of lung image registration, in particular, as compared to other types of images and anatomies is generally complex. The present technique, however, offers an effective resolution to this problem, by reference to the structures discernable in the segmented lung image data.

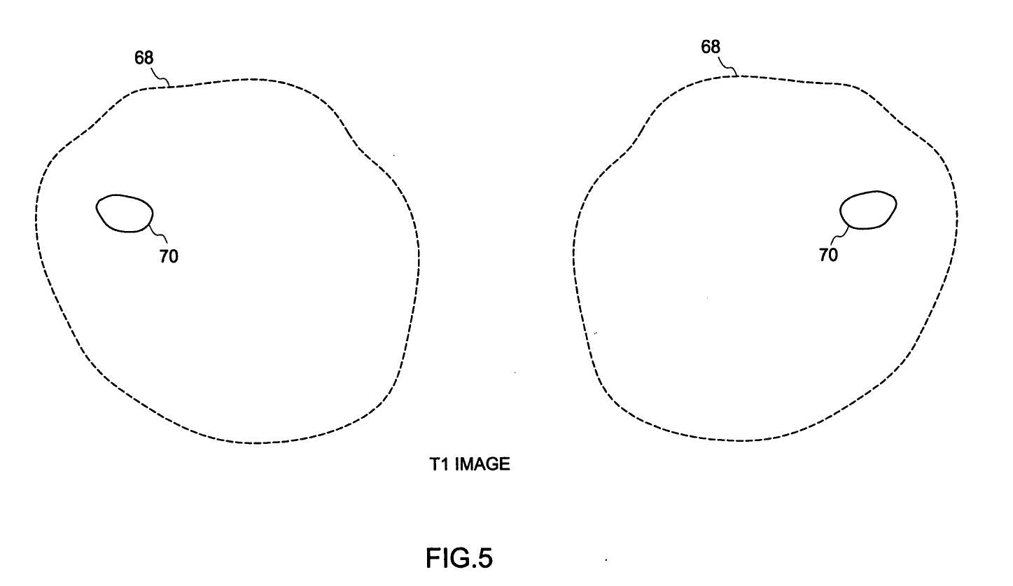

FIG. 5 is a diagrammatical representation of a segmented region of interest of lung pleural regions of the left lung 66 and the right lung 67 of the lung tissues depicted in FIG. 4 acquired at a time T1. In a specific embodiment of the present technique, the lung pleural region of interest is segmented by reference to a peripheral boundary of the lung pleural region of interest. In accordance with embodiments of the present technique, a segmentation technique is employed to identify the peripheral boundary of the lung pleural region of interest. In particular, the segmentation technique of the present technique automatically identifies the boundaries of the pleural space from the image data. As used herein, the term “boundary” refers to a set of two-dimensional (2D) contours in a slice plane or a three-dimensional (3D) surface that covers the entire volume of the pleural space. The extracted boundary is subsequently used to permit application of computer aided detection (CAD) techniques to the lung pleural region.

As will be appreciated by those skilled in the art, any suitable segmentation technique may be employed for identifying the peripheral boundary of the lung pleural region. Such techniques generally seek structures, as identified by contrast, gradients, and other analytical image characteristics, to define the limits of the regions. Certain techniques may begin with seed points, lines, figures or constructs and mathematically extend the candidate boundary inwardly or outwardly until certain mathematical limits (e.g., in contrast, intensity, gradients and so forth, or values derived from such image parameters) are reached. The pixels or voxels defining the boundary are then noted by location, to permit further processing of the bounded region, as in the present case, of the pleural regions of the lung.

More particularly, as will be appreciated by those skilled in the art, various other or particular types of segmentation may be applied to embodiments of the present technique, such as for example, iterative intensity-gradient thresholding, K-means segmentation, edge detection, edge linking, curve fitting, curve smoothing, two- and three-dimensional morphological filtering, region growing, fuzzy clustering, image/volume measurements, heuristics, knowledge-based rules, decision trees, neural networks, and so forth. Additionally, prior to segmentation, the image data may be processed to better prepare the image data for segmentation, such as in smoothing of the image data with a box-car technique, to render the image more robust and less susceptible to noise.

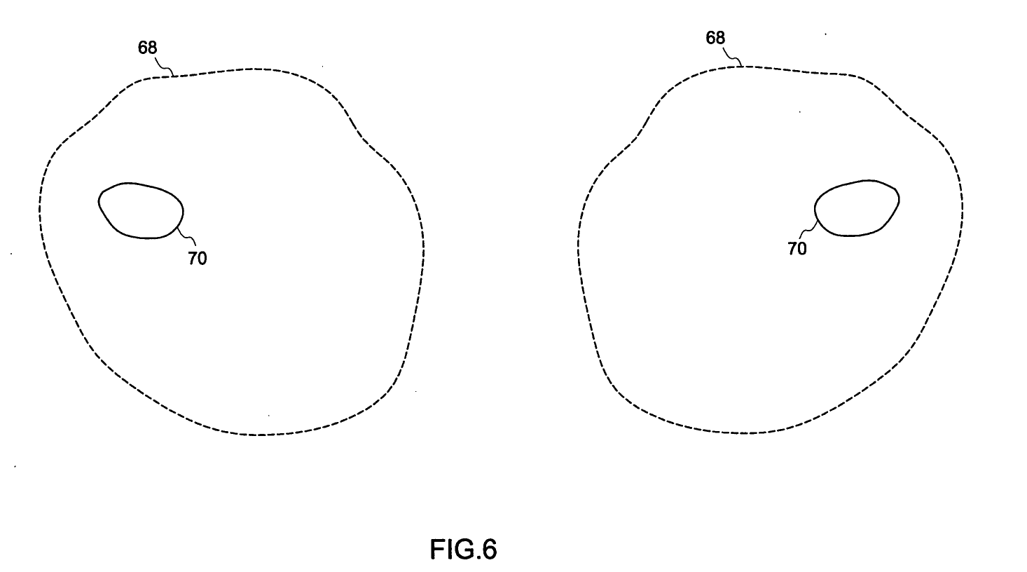

FIG. 6 is a diagrammatical representation of a segmented region of interest of the pleural regions of the left lung 66 and the right lung 67 of the same patient acquired at a different time T2. As will be noted, the magnitude of the feature of interest 70 has increased over time, offering the potential for useful comparison of the images. In conventional imaging, such comparison would be performed by viewing the images separately and developing a mental conceptualization of changes or differences between the images. As described below, in the present technique, the pleural regions are registered with one another to facilitate such comparison and analysis, either in manual, semi-automated or fully automated image analysis manners.

As depicted in FIG. 5 and FIG. 6, the segmented lung pleural images of the left and right lungs 66 and 67 respectively, represent images of the same patient's lung acquired by the same imaging modality but in different temporal settings or different sessions. Images obtained in different temporal settings enable the comparison of a current image with a historical image by a physician, or more generally of two different images. In particular, the analysis of images acquired over time enables the physician to compare and register images of a patient acquired in different temporal settings, wherein the acquisition of image data is subject to patient movements, changes caused by the image magnification factor or changes caused by the physiology of the patient under observation. Of particular interest in the clinical setting are the presence or absence of new features (e.g., indicative of potential conditions or disease states), or the progression or growth of such features, or the regression of such features, such as in response to treatment.

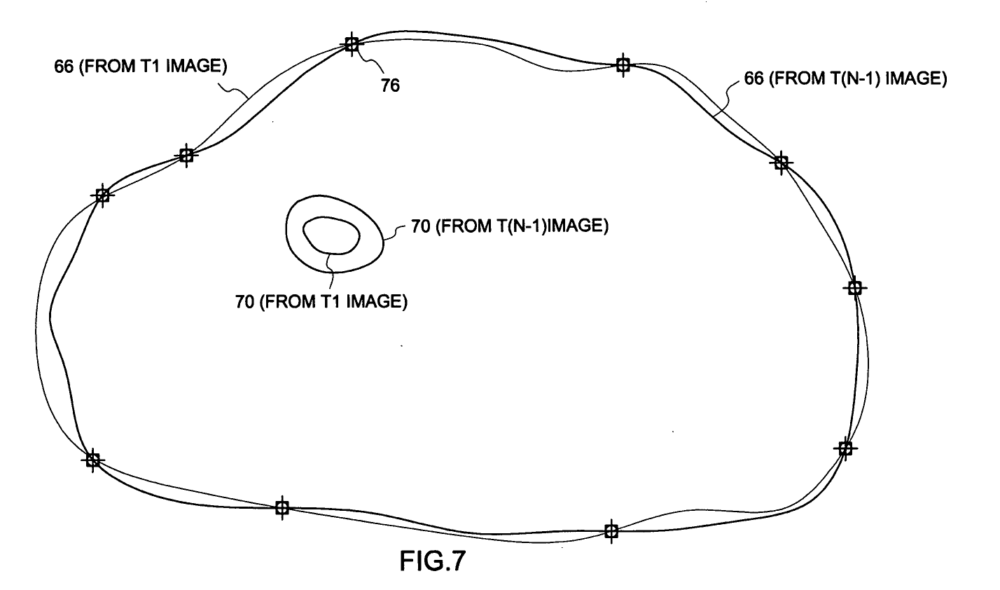

FIG. 7 is a diagrammatical representation of a digital composite image of the overlay of the pleural regions of the left lung 66 of a patient depicted in FIG. 5 and FIG. 6 acquired at different points in time. In this exemplary embodiment, the pixels are registered by reference to a peripheral boundary of the lung pleural region of interest. Reference numeral 76 represents pixel correspondences between the boundary regions comprising the left lung of the patient acquired at different points in time. The pixel correspondences 76, within the region of interest, between the boundary regions comprising the left lung 66, are then aligned to generate registered image data sets. The generation of registered image data sets in accordance with the present technique is described in greater detail below.

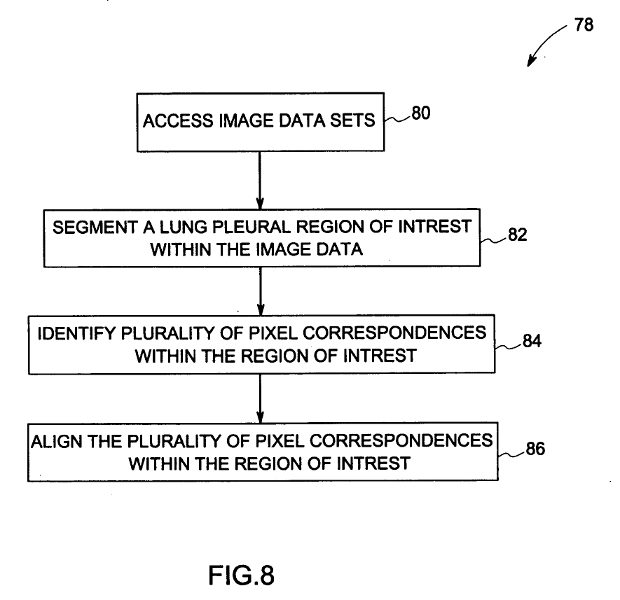

FIG. 8 is a flowchart describing exemplary steps for registering image data in accordance with embodiments of the present technique. In step 80, a plurality of image data sets comprising image data representative of a plurality of pixels are accessed. In a specific embodiment of the present technique, the image data is representative of tissue within a lung pleural region of a patient. In step 82, the lung pleural region of interest within the image data of each data set is segmented. In accordance with a specific embodiment of the present technique, the lung pleural region of interest is segmented in each image data set by reference to a peripheral boundary of the lung pleural region of interest, using the technique as described in FIG. 5. However, embodiments of the present technique may also be used to segment lung pleural regions of interest by reference to isolated airways, branching structures, vessels or lung lobe boundaries. As discussed above, any appropriate segmentation approach may be employed to identify the pleural region peripheral boundary.

In step 84, a plurality of pixel correspondences are identified within the region of interest between the image data sets. In a specific embodiment, identifying a plurality of pixel correspondences comprises using an affine iterative closest point registration (AICP) registration technique. As will be appreciated by those skilled in the art, the AICP registration technique generally comprises registering pixels using a set of transformation parameters. The AICP technique then determines a plurality of pixel correspondences between the image data sets and arrives at a set of matched pixel correspondences. Then a transformation is performed that interpolates or approximates the set of pixel correspondences between the data sets. As used herein, the term “pixel correspondences” refers to the association of two positions, one from each image data set that reference an identical position on the feature of interest or object being imaged. Moreover, in the present technique, correspondences are identified from the segmented image data sets.

Referring again to FIG. 8, in step 86, the plurality of pixel correspondences are aligned for the region of interest and between the image data sets, to generate registered data sets, wherein the lung pleural region of interest is registered between the plurality of image data sets. In accordance with embodiments of the present technique, aligning the plurality of pixel correspondences comprises registering pixels within the region of interest, wherein the pixels are registered around a peripheral boundary of the lung pleural region of interest using a thin plate spline model transformation of the image data sets. In addition, in accordance with the present technique, aligning the plurality of pixel correspondences also comprises aligning a feature of interest such as a lesion or a tumor within the region of interest, between the image data sets. The thin plate spline model transformation of the image data sets performs a warping of the features of interest based on the registration of the pixels, such as, around the boundary of the lung pleural region. As discussed above, comparison of lung images over time is complex due to the appearance of relatively diffuse tissues in the lung region. The alignment technique described above enables the comparison of pixel correspondences and features of interest within the lung pleural region. In addition, the above technique reduces the error between the pixel correspondences obtained using the AICP technique described above.

As will be appreciated by those skilled in the art, the thin plate spline model transformation technique comprises determining a minimum energy state whose resulting deformation transformation defines the registration between the image data sets. The registered data sets are then displayed to a physician for analysis. As previously discussed, in general, a clinician, such as a physician or radiologist, may analyze the registered images to detect growth or directions of growth of features of diagnostic significance, such as an anomaly, within the image.

The embodiments illustrated above describe a technique for registering image data for use in the detection and diagnosis of various conditions, such as disease states. Once registered, the images may be displayed separately or together, as described. Moreover, various further analyses may be performed, such as the automatic or semi-automatic classification of features or tissues present in the pleural regions, or the computation of characteristics of such features. These computations may include analysis growth or reduction in size of corresponding features in the temporally distinct images, both in two dimensions and in three dimensions.

It should be noted that the present technique permits registration of the entire segmented pleural region from the multiple processed images, including those regions or structures for which no correspondence was identified. Thus, aligning pixel correspondences also comprises relocating a position of a feature of interest between the image data sets. Thus, where a feature, such as a lesion or growth is identifiable in one image, the same feature of interest or location can be “relocated” automatically in a second image where the structure may be less evident. This “relocation” or “redefinition” can be presented to a physician, for instance, by placing markers or indicia on the images as the physician reviews the data sets. The physician could also navigate through the images being presented, with a list of findings from one image and, as the physician selects an item, the particular “relocated” region on the other image is displayed.

The registration technique described in the illustrated embodiments is computationally efficient and provides for better alignment and registration of images of pleural regions of the lungs. Moreover, the technique may also apply to images acquired with modalities other than CT such as for example, magnetic resonance imaging (MRI) scanners, ultrasound scanners, tomosynthesis systems and X-ray devices. Another advantage of the present technique is that the final thin plate spline alignment results in the alignment of internal structures such as lesions and growth in addition to the structures on which the correspondences are based.

The embodiments illustrated above comprise a listing of executable instructions for implementing logical functions. The listing can be embodied in any computer-readable medium for use by or in connection with a computer-based system that can retrieve, process and execute the instructions. Alternatively, some or all of the processing may be performed remotely by additional computing resources based upon raw or partially processed image data.

In the context of the present technique, the computer-readable medium is any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for registering image data comprising:
accessing a plurality of image data sets comprising image data representative of a plurality of pixels;
segmenting a lung pleural region of interest within the image data of each data set;
identifying a plurality of pixel correspondences, within the segmented region of interest, between the image data sets; and
aligning the plurality of pixel correspondences, within the segmented region of interest, between the image data sets, to generate registered image data sets in which the lung pleural region of interest is registered between the plurality of image data sets.

2. The method of claim 1, wherein the image data is acquired from image acquisition devices selected from the group consisting of computed tomography (CT) systems, magnetic resonance imaging (M) systems, tomosynthesis systems, and X-ray devices.

3. The method of claim 1, wherein the image data includes data representative of tissue within the lung pleural region of interest.

4. The method of claim 1, wherein the lung pleural region of interest is segmented in each image data set by reference to a peripheral boundary of the lung pleural region of interest.

5. The method of claim 1, wherein identifying a plurality of pixel correspondences comprises using an affine iterative closest point technique.

6. The method of claim 1, wherein aligning the plurality of pixel correspondences comprises registering pixels within the region of interest.

7. The method of claim 6, wherein the pixels are registered around a peripheral boundary of the lung pleural region of interest.

8. The method of claim 1, wherein aligning the plurality of pixel correspondences comprises a thin plate spline model transformation of the image data sets.

9. The method of claim 1, wherein aligning the plurality of pixel correspondences comprises aligning a feature of interest within the region of interest, between the image data sets.

10. The method of claim 9, wherein aligning the plurality of pixel correspondences further comprises relocating a position of the feature of interest between the image data sets.

11. The method of claim 1, further comprising displaying an image based upon the registered image data sets.

12. A method for registering image data comprising:
accessing a plurality of image data sets comprising image data representative of a plurality of pixels;
segmenting a lung pleural region of interest within the image data of each data set;
identifying a plurality of pixel correspondences, within the segmented region of interest, between the image data sets;
performing an affine iterative closest point correspondence of pixels within the segmented region of interest based on the identified plurality of pixel correspondences; and
aligning the identified plurality of pixel correspondences, within the segmented region of interest, between the image data sets using a thin plate spline model transformation of the image data sets;

13. The method of claim 12, wherein the image data is acquired from image acquisition devices selected from the group consisting of computed tomography (CT) systems, magnetic resonance imaging (MRI) systems, tomosynthesis systems, and X-ray devices.

14. The method of claim 12, wherein the image data includes data representative of tissue within the lung pleural region of interest.

15. The method of claim 12, wherein the lung pleural region of interest is segmented in each image data set by reference to a peripheral boundary of the lung pleural region of interest.

16. The method of claim 12, wherein aligning the plurality of pixel correspondences within the region of interest comprises registering the pixels within the region of interest, to generate registered image data sets.

17. The method of claim 14, wherein the lung pleural region of interest is registered between the plurality of image data sets.

18. The method of claim 16, wherein aligning the plurality of pixel correspondences comprises aligning a feature of interest within the region of interest, between the image data sets.

19. The method of claim 18, wherein aligning the plurality of pixel correspondences further comprises relocating a position of the feature of interest between the image data sets.

20. The method of claim 16, further comprising displaying an image based upon the registered image data sets.

21. An imaging system for registering image data comprising:
an X-ray source configured to project an X-ray beam from a plurality of positions through a subject of interest;
a detector configured to produce a plurality of signals corresponding to the X- ray beam; and
a processor configured to process the plurality of signals to generate the image data, the image data representative of a plurality of pixels, wherein the processor is further configured to access a plurality of image data sets comprising the image data;
segment a lung pleural region of interest within the image data of each data set;
identify a plurality of pixel correspondences, within the segmented region of interest, between the image data sets; and align the plurality of pixel correspondences, within the segmented region of interest, between the image data sets, to generate registered image data sets in which the lung pleural region of interest is registered between the plurality of image data sets.

22. An imaging system for registering image data comprising:
means for processing a plurality of signals to generate the image data, the image data representative of a plurality of pixels, wherein the processor is further configured to access a plurality of image data sets comprising the image data; segment a lung pleural region of interest within the image data of each data set; identify a plurality of pixel correspondences, within the segmented region of interest, between the image data sets; and align the plurality of pixel correspondences, within the segmented region of interest, between the image data sets, to generate registered image data sets in which the lung pleural region of interest is registered between the plurality of image data sets.

23. A computer-readable medium storing computer instructions for instructing a computer system to register image data comprising:
accessing a plurality of image data sets comprising image data representative of a plurality of pixels;
segmenting a lung pleural region of interest within the image data of each data set;
identifying a plurality of pixel correspondences, within the segmented region of interest, between the image data sets; and
aligning the plurality of pixel correspondences, within the segmented region of interest, between the image data sets, to generate registered image data sets in which the lung pleural region of interest is registered between the plurality of image data sets.

24. A computer-readable medium storing computer instructions for instructing a computer system to register image data comprising:
accessing a plurality of image data sets comprising image data representative of a plurality of pixels;
segmenting a lung pleural region of interest within the image data of each data set;
identifying a plurality of pixel correspondences, within the segmented region of interest, between the image data sets;
performing an affine iterative closest point correspondence of pixels within the segmented region of interest based on the identified plurality of pixel correspondences; and
aligning the identified plurality of pixel correspondences, within the segmented region of interest, between the image data sets using a thin plate spline model transformation of the image data sets;
